(19) United States
(12) Patent Application Publication
(10) Pub. No.: US 2012/0089650 A1
(43) Pub. Date: Apr. 12, 2012

(54) SYSTEM AND METHOD FOR A STORAGE SYSTEM

(75) Inventors: Justin Theodore Gibbs, Boulder, CO (US); Joshua Daniel Carter, Lafayette, CO (US)

(73) Assignee: Spectra Logic Corporation, Boulder, CO (US)

(21) Appl. No.: 12/900,719

(22) Filed: Oct. 8, 2010

(51) Int. Cl. G06F 17/30

(52) U.S. Cl. 707/822; 718/1; 707/E17.01

(57) ABSTRACT

Provided is a system and method for a system for a storage system. The system includes a policy based file system and a virtualization environment permitting native file system primitives among a plurality of virtual machines. Each virtual machine has a virtual file system. Each virtual file system structured and arranged with native file system operations to access, based on policy, a portion of the policy based file system. An associated method is also provided.

### CROSS-REFERENCE TO RELATED APPLICATIONS

None.

### BACKGROUND OF THE INVENTION

1. Field of the Invention

The present invention relates generally to systems and methods for data storage, and more specifically to systems and methods of data storage and access for virtual machines.

2. Description of Related Art

Computer systems, also referred to as programmable machines, commonly perform an ever increasing array of tasks to aid people in personal and professional ways. Physically, the programmable machine generally includes a case enclosing a main board having a system bus, connection ports, one or more processing units such as a Central Processing Unit (CPU) and one or more memory storage devices, such as main memory (RAM, for example) and a hard drive.

These physical components are collectively brought together as a working programmable machine by an operating system, which in turn permits applications to customize and adapt the resources of the machine to perform one or more specialized tasks. For many applications, a key element for the operating system is to permit the application to enjoy file-system access for the exchange of data.

Moreover, applications typically require performing file-system operations such as read/write/delete/etc. . . . for both files and directories. These operations are traditionally provided by the operating system utilizing an application programming interface, “API” with one or more abstractions for interfacing with the physical storage devices. Generally these abstractions can be viewed as layers transitioning from the software environment to the hardware environment.

Where the physical storage is directly connected to the machine, the file-system abstractions achieve block access with the storage device—i.e. a generic file system service received the read/write/create/etc. . . . operation and interfaces with a file system driver. The file system driver utilizes generic block services which are then accorded the appropriate protocol for the SAS/SATA/FC/iSCSI or other type of physical storage device. The protocol then interacts with a device driver and the operation is performed.

FIG. 1 illustrates a general bare metal configuration of a programmable machine 100, with the physical elements of memory 102, CPUs 104, connection port 106 and storage devices 108 shown on the left and a conceptual mapping of the abstraction layers for file-system access shown on the right.

Although improvements in manufacturing have reduced the costs associated with physical components, and therefore also reduced the cost of the programmable machine, in many instances the total resources of a machine are not utilized continuously.

In light of this, in many situations it has been found that a physical machine can be adapted to provide a plurality of virtual machines—each an efficient, and functional equivalent of a real physical machine. Each virtual machine can provide a complete system platform that supports the execution of a complete operating system and any associated applications.

Because one physical programming machine can support multiple virtual machines, the cost benefits of utilizing virtual machines over individual physical machines can be advantageous.

In general, each virtual machine is an emulation of a physical machine, including a virtualization of the physical components, such as storage devices, for example. Hence, the virtual machine executes software to perform file-system operations on its virtualized storage devices. In addition, and perhaps even more significant, is the issue that the virtual file system of one virtual machine is distinct from the virtual file system of another virtual machine. Moreover, each virtual machine has its own copy of a file-system, and the files therein, that is distinct from every other virtual machine.

The analogy of two identical physical computers, A and B, running side by side illustrates that the files on the hard drive of computer A are indeed separate and distinct from the files on the hard drive of computer B. The block access performed by computer A and its hard drive is entirely separate from the block access performed by computer B and its hard drive. Content sharing is not permitted.

For the virtual machine, file-system data is stored on a virtual storage device, which is indeed itself backed by a file (typically a large file) housed by the underlying physical machine. As shown in FIG. 2, the virtual machine 200 performs file system operations abstracting block access to its virtual storage device. As this file-system is actually backed by a file on the physical machine, a virtual block device 202 interfaces with the physical machine 204 so as to engage abstractions yet again for block access to the actual physical file.

Not only does this impose some latency on both the virtual machine and the physical machine, but virtual byte blocks will not correlate to physical bite blocks. As such, the information in the physical file is akin to unrecognizable gibberish to all machines except for its associated virtual machine. Further still, the issue of file duplication for each instance of a virtual file-system implies that the physical file space of the physical machine lacks efficiency.

Of course, networking computers is a common method of sharing information and content between computers. Virtual machines can be established that have virtual network interfaces as well. These virtual network interfaces permit virtual machines to exchange file content with: a) other virtual machines, b) the underlying physical machine supporting the virtual machines and/or c) other physical machines.

FIG. 3 illustrates a conceptual depiction of the network file-system abstractions, for a virtual machine 300 connecting to a second machine 302. In varying instances, the second machine may be the underlying physical machine or another virtual machine. Regardless, it is clear that many layers of virtual abstraction are again present. It is also apparent that regardless of what file-system action is desired, that action must be translated through additional network protocols. Where byte blocking as illustrated in FIG. 2 is also employed, the additional levels of duplicated effort are even greater.

It is to innovations related to this subject matter that the claimed invention is generally directed.

### SUMMARY OF THE INVENTION

This invention provides a system and method for data storage, and more specifically to systems and methods of data storage and access for virtual machines.

In particular, and by way of example only, according to one embodiment of the present invention, provided is a storage system including: a policy based file system; and a virtualization environment permitting native file system primitives among a plurality of virtual machines, each virtual machine having a virtual file system, each virtual file system structured and arranged with native file system operations to access, based on policy, a portion of the policy based file system.

In another embodiment, provided is a method for a storage system including:

providing a policy based file system; providing a virtualization environment permitting native file system primitives for virtual machines; providing a plurality of virtual machines each having a virtual file system that is structured and arranged with the native file primitives to access at least a portion of the policy based file system; and permitting the virtual machines to interact operatively with the policy based file system based on a predetermined access policy associated with each of the virtual machines.

In yet another embodiment, provided is a storage system including: means for providing a policy based file system; means for providing a virtualization environment permitting native file system primitives for virtual machines; means for providing a plurality of virtual machines each having a virtual file system that is structured and arranged with native file primitives to access at least a portion of the policy based file system; and means for permitting the virtual machines to operatively interact with the policy based file system based on each virtual machines predetermined access policy.

Further still, in yet another embodiment, provided is a storage system for virtual machines including: at least one processing unit; at least one memory storage device coupled to the processing unit; an input device coupled to the processing unit; an output device coupled to the processing unit; the processing unit being operative to adapt the storage system as a dedicated storage system for virtual machines by: providing a policy based file system having one or more files therein; providing a virtualization environment permitting native file system primitives for virtual machines; providing a plurality of virtual machines each having a virtual file system that is structured and arranged with the native file primitives to access at least a portion of the policy based file system; and permitting the virtual machines to operatively interact with the policy based file system based on a predetermined access policy associated with each of the virtual machines.

### BRIEF DESCRIPTION OF THE DRAWINGS

At least one system and method of data storage will be described, by way of example, in the detailed description below with particular reference to the accompanying drawings in which like numerals refer to like elements, and:

FIG. 1 illustrates a conceptual bare metal configuration for a computing machine;

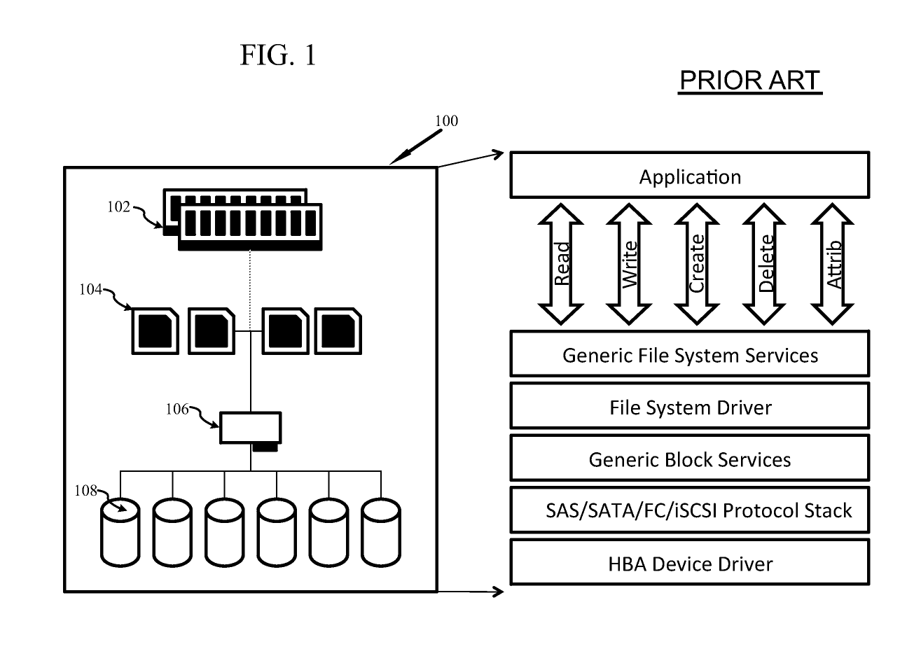

FIG. 2 is a conceptual illustration of the traditional abstractions involved in a virtual machine and a non-virtual machine cooperatively achieving file access operations;

FIG. 3 is a conceptual illustration of the traditional abstractions involved in a virtual machine and a non-virtual machine and a virtual network device to cooperatively achieving file access operations;

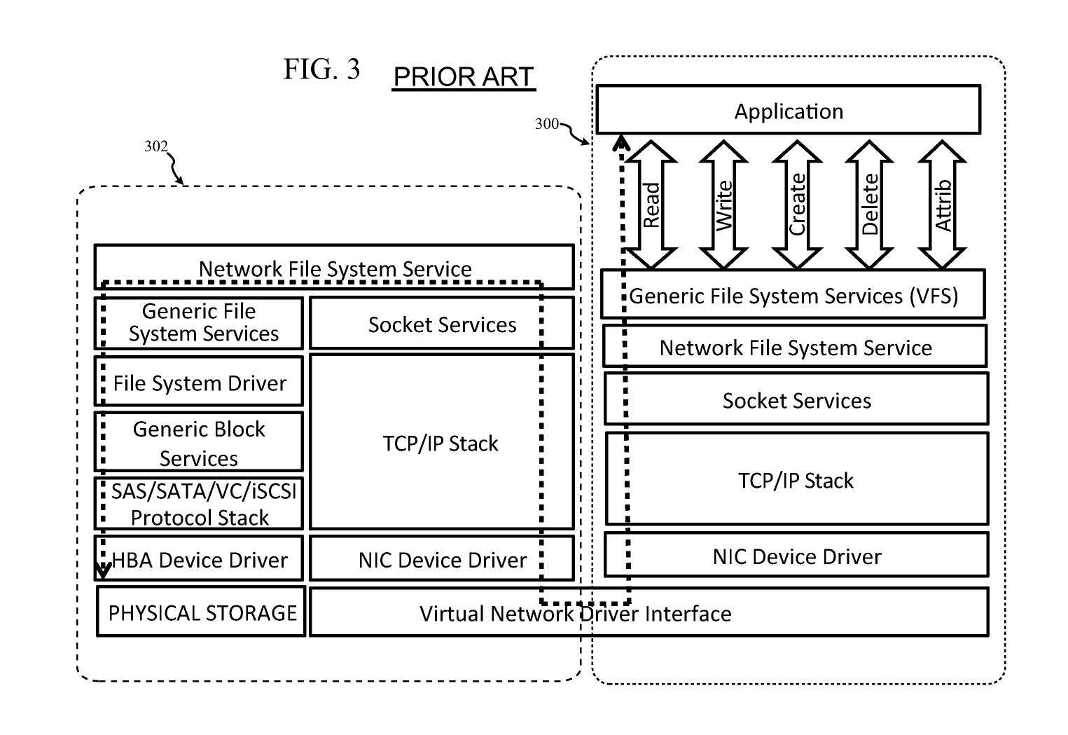

FIG. 4 a block diagram of a storage system in accordance with at least one embodiment;

FIG. 5 is high level flow diagram of a method for a storage system in accordance with at least one embodiment;

FIG. 6 is a conceptual illustration of the abstractions involved in a storage system and/or method in accordance with at least one embodiment; and

FIG. 7 is a block diagram of a computer system in accordance with at least one embodiment.

### DETAILED DESCRIPTION

Before proceeding with the detailed description, it is to be appreciated that the present teaching is by way of example only, not by limitation. The concepts herein are not limited to use or application with a specific system or method of data storage, or specifically data storage for virtual machines. Thus, although the instrumentalities described herein are for the convenience of explanation shown and described with respect to exemplary embodiments, it will be understood and appreciated that the principles herein may be applied equally in other types of systems and methods of data storage.

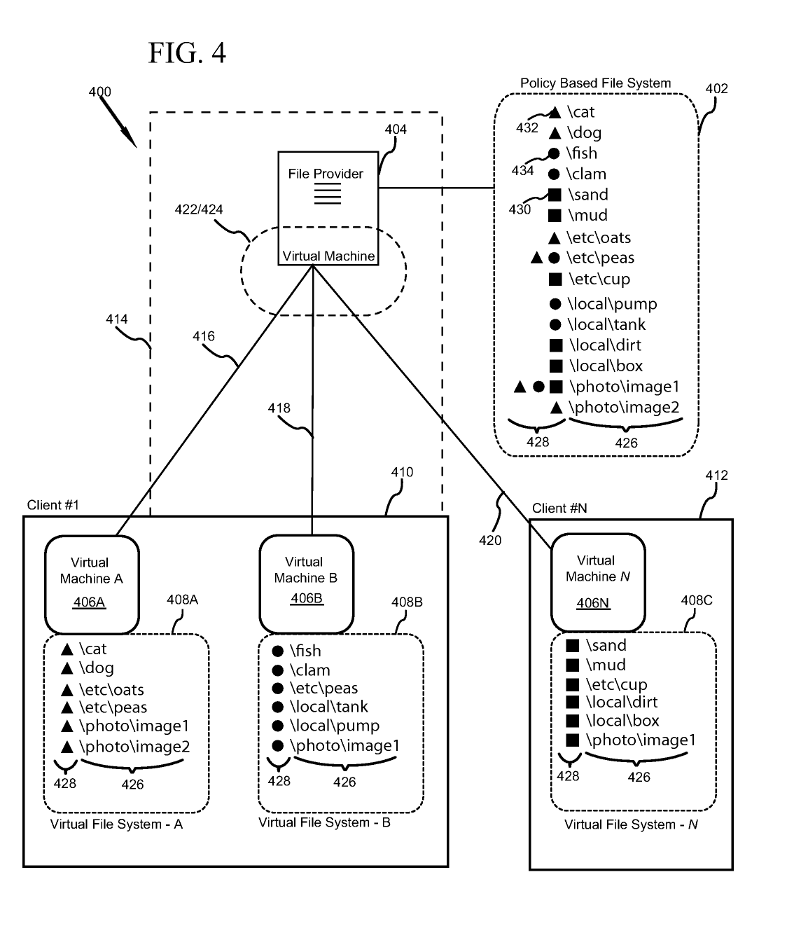

Turning now to the drawings, and more specifically FIG. 4, illustrated is a high-level block diagram of a storage system 400 in accordance with at least one embodiment. As shown, the storage system 400 generally comprises a policy based file system 402 provided by a file provider 404 and a plurality of virtual machines 406, of which virtual machines 406A, 406B and 406N are exemplary. Storage system 400 is a virtualization environment permitting native file system primitives among the virtual machines 406 and the policy based file system 402.

As used herein, virtualization environment is understood and appreciated to be an environment wherein the virtual machines are operable as if they were physical machines, and in which their respective file system interactions are native file system interactions performed as if upon a physical, i.e., non-virtual storage device without virtual blocking or other translation. The virtualization environment includes appropriate mechanisms for partitioning physical resources amongst one or more virtual machines, and for defining and enforcing policies surrounding that partitioning.

More specifically, each virtual machine 406 has a file system represented as virtual file system 408, of which virtual file systems 408A, 408B and 408N are exemplary and respective to the virtual machines 406A, 406B and 406N. Each virtual machine's 406 file system is termed as a virtual file system 408 as it is the policy based view of the entire policy based file system 402—it may be a complete view or a partial view, but is perceived by the virtual machine 406 as if it were the only instance of a complete file system. Each virtual file system 408 is structured and arranged with native file system operations to access, based on policy, a portion of the policy based file system 402. In at least one embodiment these file system operations are understood and appreciated to be read, write, delete, and create operations.

In other words, a policy filter insures that each virtual machine 408 has access to certain files based on policy. It is also understood and appreciated that the policy filter may, in at least one embodiment, modify one or more attributes of the file or directory to which the virtual machine 408 is being given access. These attributes may include, but are certainly not limited to, owner, name, content, location in the directory hierarchy, etc. . . . For ease of illustration and discussion, and not for limitation, the examples shown and described herein involve access.

The term “native”, as used, for example, with native file system primitives and native file system operations, is defined by operations that are performed directly upon the physical policy based file system and without the translation from the virtual environment to the physical environment, such as by virtual block to physical block mapping or virtual IP packetization, as set forth above. More specifically, “native”, as used herein, is understood to imply that the operations occur as if truly local, as in a physical part of and indigenous to the system providing the policy based file system 402.

In at least one embodiment, virtual machines 406 are understood and appreciated to be systems that emulate physical systems, such as that which might be used by at least one human operator and/or by some software or hardware system. These system are operationally equivalent to physical systems that could be used or adaptively configured to perform the same tasks and or operations, but they exist as virtual, i.e., non-physical systems. More specifically, virtual machines 406 are systems which are capable of and intended for use in processing applications and data as may be desired by a user or by some software or hardware system.

As is shown, virtual machines 406A and 406B are provided by a first physical machine 410, i.e., client 1. It should be understood and appreciated, within the scope and spirit of embodiments exemplifying the present invention that the first physical machine 410 may provide a plurality of virtual machines 406. In addition, in at least one embodiment, additional virtual machines 406, such as virtual machine 406N, are provided by at least one second physical machine 412.

In at least one embodiment, the file provider 404, or more specifically the policy based file system 402, is provided by one or more non-virtual machines, i.e., one or more physical machines. More specifically, in varying embodiments, the policy based file system 402 may be a central policy based file system or a distributed policy based file system.

In at least one alternative embodiment, the file provider 404, or more specifically the policy based file system 402, is provided by a virtual machine provided by the first physical machine 410, suggested by dotted line 414 incorporating the file provider 404 as part of first physical machine 410. Moreover, the virtual machine acting as the file provider 404 is substantially the same as virtual machines 406, but with policy access sufficient for access and control of the policy based file system 402. More specifically, this virtual machine has been granted, via a policy of the virtualization environment, access to the underlying physical storage resources and implements the policy based file-system on the physical storage resources.

Again, FIG. 4 has been prepared and provided for ease of illustration and discussion. With respect to the virtual machines 406 and their interaction with the policy based file system 402, especially for embodiments wherein a first physical system 410 is providing substantially all of the virtual machines 406 including the virtual machine acting as the file provider 404, the paths of connection 416, 418 between virtual machines 406A, 406B and the file provider 404 are akin to a virtual bus as the virtual machines are enjoying shared memory provided by the physical system. With respect to the virtual machines 406N provided by a second physical system 412, the paths of connection 420 are again not traditional network pathways, but rather remote DMA such that the system bus of physical system 412 appears to be an extension of the system bus of physical system 410. Moreover, storage system 400 is not merely a clustered file system or other network file system with a file server. The use of the term “file provider” as with respect to file provider 404 is specifically intended to convey understanding that this system is not merely a network file server, but a controlling entity permitting policy based access and operation upon the policy based file system 402 within the shared memory environment.

In at least one embodiment, one of the virtual machines 406 is deemed a first virtual machine 422, such as is structured and arranged with a policy setting for managing the policy based file system 402 in its entirety. In such an embodiment, other virtual machines 406 may be identified as second virtual machines, each having policy based access to at least a portion of the policy based file system 402 via the first virtual machine 422. In varying embodiments, the operation of the first virtual machine 422 to administer access to the policy based file system 402 is transparent to the second virtual machines.

Moreover, in at least one embodiment, storage system 400 has a policy enforcement agent 424 that controls policy based access for at least one of the virtual machines 406. In varying embodiments, this policy enforcement agent 424 may be a virtual machine, such as, first virtual machine 422, the virtualization environment, or a non-virtual machine.

More specifically, there are generally three components interacting to achieve storage system 400, the virtual machines 406 with a policy based view into the policy based file system 402, the virtualization environment that supports the transmission of the file-system primitives, and the destination environment, a virtual machine, a physical machine or the virtualization environment that manages the policy based file system 402. Policy can be imposed at any point in the communications between components, or upon any component. For example, a virtual machine 406B could impose some policy such as case-insensitivity without any knowledge of this policy passing to the other components. Similarly, the virtualization environment could trap each submitted file-system operation and impose it's own policy. The same applies to the destination environment, and the underlying file system.

Again, as suggested by dotted line 414 extending from first physical system 410, it is also understood and appreciated that the policy based file system 402 and at least a subset of the plurality of virtual machines 406 can be provided by the same physical system. Such co-location of the policy based file system 402 and the virtual machines may be advantageous for maximizing speed and performance for at least some of the virtual machines 406.

For example, a first computer system may be adapted to operate as the policy based file system 402. This same first computer system may further be a virtual machine adapted as a policy enforcement agent 424 controlling policy based access to the policy based file system 402 for at least one virtual machine 406. Each virtual machine 406 is adapted to operate as a machine configured in accordance with the specific needs of one or more users and or applications interacting with the virtual machine. For example, the virtual machines may be adapted to operate as a music library system, a video library system, a social media and networking site, an auction system, an airline reservation system, or other desired system. Indeed, as each virtual machine is established and adapted for at least one specific operation and is operationally equivalent to a physical, e.g., non-virtual machine, but without the associated costs of hardware, space and power, the use of virtual machines 106 is, therefore, desirable and their integration with storage system 400 is highly advantageous.

With respect to FIG. 4, and specifically the depiction of the policy based file system 402, shown therein is an exemplary selection of files 426 and at least one associated policy 428, depicted as a Square “▪” 430, Triangle “▴” 432, or Disc “” 434, for ease of illustration and discussion.

Files with a policy 428 shown as Triangle 432 are associated with virtual machine 406A as virtual file system 408A. Files with a policy 428 shown as a Disc 434 are associated with virtual machine 406B as virtual file system 408B, and files with a policy 428 shown as a Square 430 are associated with virtual machine 406N as virtual file system 408N.

Moreover, the policy based access of each virtual machine 406 permits at least partial access to the policy based file system 402. More simply, those files to which a virtual machine 406 is permitted access by policy setting are shown and accessible as part of the virtual file system 408. Those files to which the virtual machine 406 is not authorized by policy are not shown as part of the virtual file system 408.

In addition, within storage system 400, at least two virtual machines 406 possess virtual file systems 408 that are structured and arranged to natively access a single instance of a file in the policy based file system 402. For example, with respect to these apparent virtual file systems 408 it will be appreciated that a single instance of the exemplary file “peas” in the directory “\etc” is shared by both virtual machine 406A and virtual machine 406B as it appears in their respective virtual file systems 408A and 408B. As such, storage system 400 advantageously avoids file duplication.

Each virtual file system 408 also appears as a local file system provided by a non-volatile storage device to its associated virtual machine. In other words, just as a desktop, laptop, or other system can review files locally available from a hard drive, optical drive, jump drive or other non-volatile storage system, so too does the virtual file system 408 appear to the associated virtual machine 406.

In addition, each virtual file system 408 appears as a complete file system. More specifically, policy based file system 402 shows three files existing in the subdirectory “\etc”, however, virtual file system 408A shows two (\etc\oats and \etc\peas), virtual file system 408B shows one (\etc\peas) and virtual file system 408N shows one (\etc\cup), see Table A. Each virtual file system 408 does not provide an indication that the associated files shown therewith are part of a larger system; rather the associated files are displayed exactly as if they were locally available via a non-volatile storage device.

TABLE A

| Policy Based File | Virtual File | Virtual File | Virtual File |
|---|---|---|---|
| System 402 | System 408A | System 408B | System 408N |
| \etc\oats | \etc\oats | \etc\peas | \etc\cup |
| \etc\peas | \etc\peas | | |
| \etc\cup | | | |

It is of course understood and appreciated that the exemplary files 426 are named for ease of discussion and illustration. Embodiments of storage system 400 may certainly contain files of varying types such as music, video, image, system files, word processing documents, applications, etc.

In addition, the example file system shown in FIG. 4, and at least partially in Table A is of course modeling a typical file system using a file/directory hierarchy to organize data. It is understood and appreciated that varying embodiments of the present invention are equally adaptable to other methods of data organization, such as but not otherwise limited to, a flat namespace where all objects are accessed by a unique identifier, such as an ID value.

Moreover, it is understood and appreciated that because a single instance of a file can be shared by multiple virtual machines 406, in situations where the level of permission access is sufficient to permit changes to the file, safeguards can be implemented to engage versioning of the file (e.g., peas.1, peas.2, etc. . . . ) and/or atomic assurance that different systems do not attempt simultaneous update. In situations where the file is simply accessed, such as a system file, read-only music or video file, or other generally non-evolving type of file, such implementation of safeguards may not be desired.

More specifically storage system 400 is not limited to any specific type of files 426. In addition, as different virtual machines may take many forms, for example a virtual Windows® machine, a virtual Mac® machine, a virtual Linux® machine, a virtual FreeBSD® machine, etc. The file types appropriate for one virtual machine may not be directly appropriate and/or usable by different virtual machines, however their respective files can be maintained and natively accessed in the policy based file system 402.

Moreover, as the files present in each virtual file system 408 are natively accessed in the policy based file system 402, it is understood and appreciated that the portion of the policy based file system 402 available to each virtual machine 406 is not remapped to a file that is structured and arranged as a virtual non-volatile storage access device.

Not only does this alleviate the need for file duplication, such as between different virtual machines, as noted above, but it also increases response time in the execution of file system primitives. In addition, the common availability of the files in the policy based file system 402 permits advantages of essentially real-time maintenance operations.

For example, a new virtual machine 406 can be established with policy rights of a varying degree so as to scrub the files 426 of the policy based file system 402 for viruses, resample audio files, create image thumbnails or perform some other essentially real-time maintenance operation without otherwise affecting one or more of the virtual machines 406.

With respect to the policy based file system 402, in at least one embodiment the policy 428 maps owners, i.e., virtual machines 406. It is also understood and appreciated that in varying embodiments a granularity of policy rights are also provided, such as, for example, Read, Write, Execute and combinations thereof. In other words, two virtual machines 406 may have policy based access to the same file 426 (for example \etc\peas), but only one virtual machine 406A, has policy rights permitting modification of the file 426.

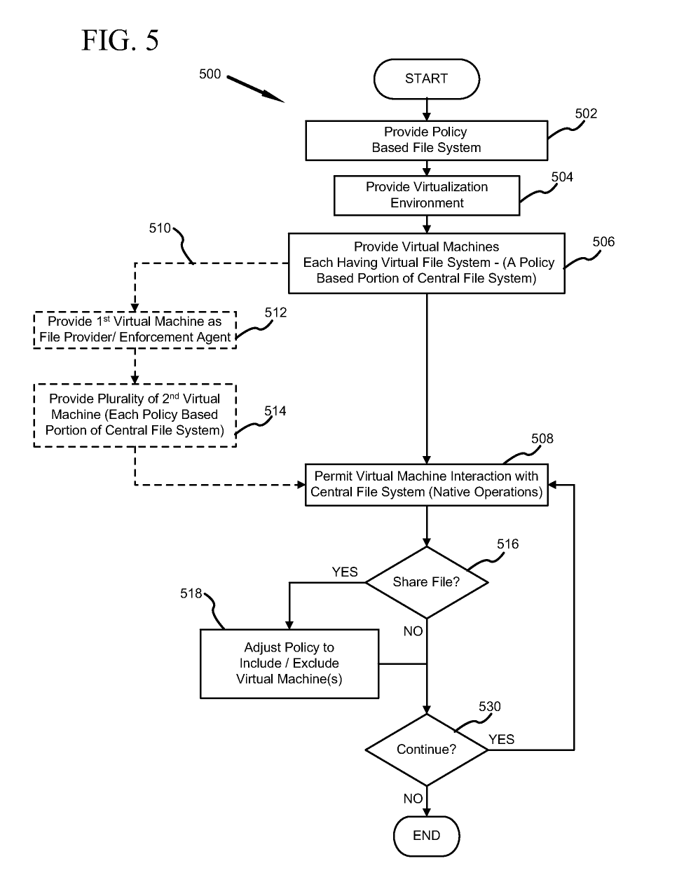

FIG. 5 in connection with FIG. 4 provides a high level flow diagram with conceptual illustrations depicting at least one method 500 for storage system 400. It will be appreciated that the described method need not be performed in the order in which it is herein described, but that this description is merely exemplary of one method of a storage system 400.

In at least one embodiment, the method 500 commences with the providing or establishing of a policy based file system 402, block 502. In varying embodiments, the policy based file system 402 may be structured and arranged as a central file system provided by one or more physical machines or a networked file system. The policy based file system 402 may also be administered by a true physical machine, i.e., a non-virtual machine, adapted to operate as a policy enforcement agent that controls access to the policy based file system.

A virtualization environment is also provided permitting native file system primitives for virtual machines, block 504. In at least one embodiment, this virtualization environment is established by the use of Xen, a virtual machine monitor developed by the University of Cambridge Computer Laboratory for IA-32, x86-64, Itanium and PowerPC 970 architectures, permitting multiple virtual machines identified as guest operating systems to execute on the same physical computer hardware concurrently. Xen utilizes a small, hyper-privileged virtual machine monitor to control access to the physical resources and share them among other virtual machines. It additionally provides shared memory and interrupt services allowing efficient inter-virtual-machine communication.

A plurality of virtual machines 406 each associated with a virtual file system 408 are then provided. Each virtual file system is structured and arranged with native file primitives to access at least a portion of the policy based file system 402, block 506.

The method 500 is fully realized by permitting the virtual machines 406 to operatively interact with the policy based file system 402 based on a predetermined access policy associated with each of the virtual machines 406, block 508. For example, with respect to FIG. 4, the predetermined access policy is for virtual machine 406A to have policy based access to files identified by the policy 428 shown as a Triangle “▴” 432, virtual machine 406B to have policy based access to files identified by the policy 428 shown as a Disc “” 434, and virtual machine 406N to have policy based access to the files identified by a Square “▪” 430.

As indicated by dotted path 510, in at least one optional embodiment of method 500, a first virtual machine is provided for the policy based file system 402, block 512. In varying configurations, this first virtual machine may also be considered the policy enforcement agent. A plurality of second virtual machines, e.g., virtual machines 406, are then provided, each having policy based access to at least a part of the policy based file system 402 through the first virtual machine, block 514.

As indicated above in Table A and shown in FIG. 4, method 500 permits natively allocating a single instance of a file in the policy based file system 402 to at least two of the virtual machines in accordance with the access policy of each virtual machine. For example, as shown in FIG. 4, both virtual machine 406A and virtual machine 406B have been allocated policy based access to the single instance of the file 426/etc/peas.

In addition, the policy agent is operable to adjust policy settings in about real time. This not only permits the instantiation of a new virtual machine 406 for a third party user or application to immediately enjoy desired file access, but it can also permit instantiation of a new virtual machine 406 for essentially real-time file maintenance on the policy based file system 402 concurrently with access of the policy based file system by one or more of the virtual machines 406. In varying embodiments, one virtual machine 406 may also be structured and arranged to impose or request a policy adjustment so as to permit one or more other virtual machines to also access a common file.

Moreover, method 500 continues in at least one embodiment, by permitting one or more virtual machines 406 to share a file, decision 516. Where a decision is made to share a file, the necessary adjustment is made to the policy based file system 402. It is understood and appreciated that the decision to share a file can be both inclusive, giving access rights, as well as exclusive, removing access rights, block 518.

This highly flexible ability of adjustment is advantageous. Not only can virtual machines be created without excessive file duplication, the removal of a virtual machine is simplified as the constituents of the virtual file system 408 need not be deleted. As the virtual file system was established by references to the policy based file system 402, an update to the policy effectively removes the deleted virtual machine 406 and it's associated file system 408 without requiring the deletion of any files within the policy based file system 402. A house keeping operation may certainly be implemented in varying embodiments to delete files in the policy based file system 402 that are not otherwise referenced by any active virtual machine 406.

Moreover, with respect to method 500, it is again understood and appreciated that the portion of the policy based file system 402 available to one or more of the virtual machines 406 is not remapped to a file that is structured and arranged as a virtual non-volatile storage access device.

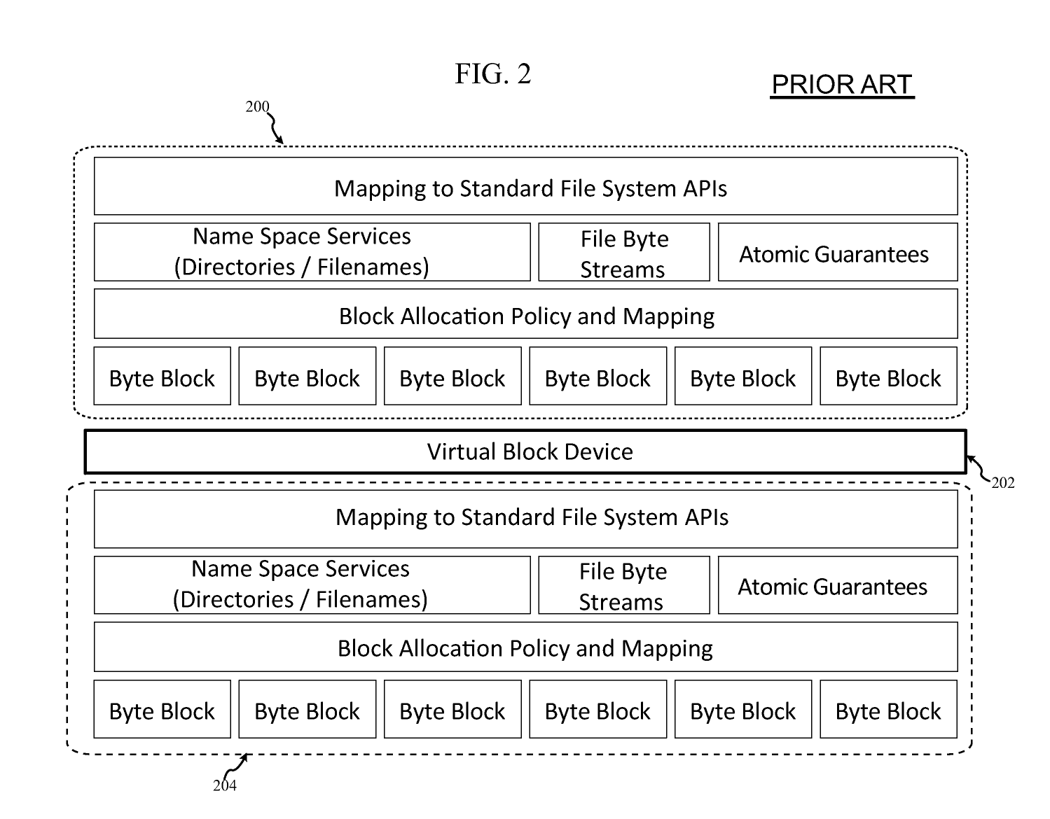

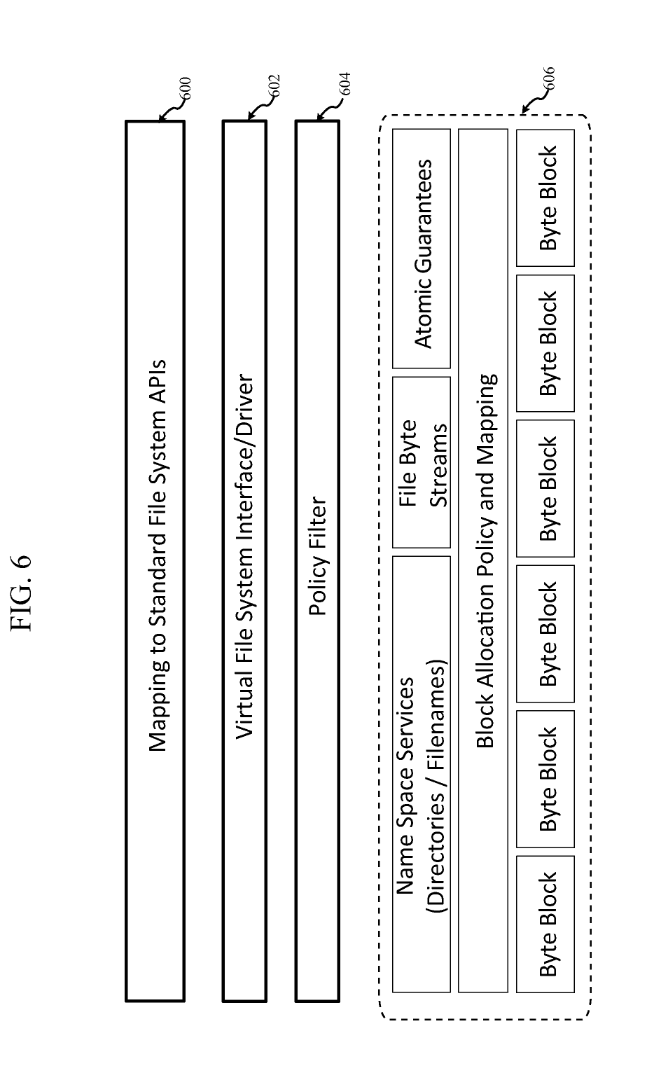

Indeed, FIG. 6 further illustrates this advantageous nature of storage system 400 and method 500. As shown, for storage system 400 and method 500, a file system primitive commences in the traditional way with mapping to the standard file system application programming interface “ API”, as shown by element 600. However, in sharp contrast to the prior art depiction of FIG. 2 where there is a mapping to byte blocks in the virtual machine 200, and a mapping to byte blocks in the physical non-virtual machine 204 after transitioning across the virtual block device 202, in the environment of storage system 400 and method 500, the mapping 600 directed by the file operation primitive transitions directly across the virtual file system interface or driver 602, is adjusted by the policy filter 604 and then proceeds a traditional native operation/abstractions 606.

Moreover, as a visual comparison of FIGS. 2 and 6 makes clear, storage system 400 and method 500 simplifies the file access operations by avoiding the abstractions for file access within the virtual environment. Not only does this reduce the processing time associated with such virtualization, reduce the opportunity for an error or disruption to occur, but this also permits the files to be directly accessible from other virtual machines 406 and/or simply from outside the virtual machine environment.

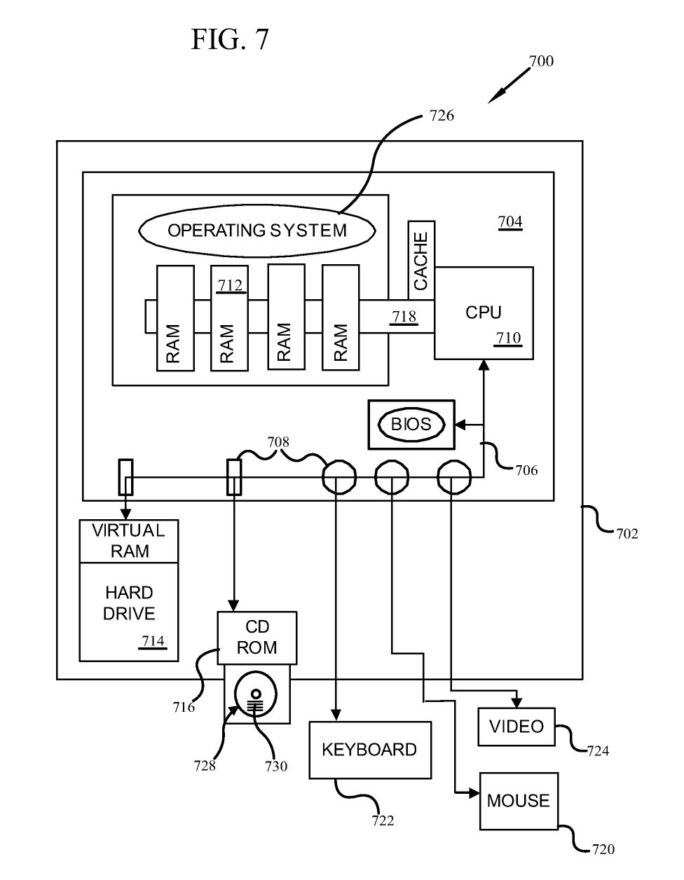

With respect to the above description of storage system 400 and method 500 it is understood and appreciated that the method may be rendered in a variety of different forms of code and instruction as may be used for different computer systems and environments. To expand upon the initial suggestion of a computer implementation above, FIG. 7 is a high level block diagram of an exemplary computer system 700. Computer system 700 has a case 702, enclosing a main board 704. The main board has a system bus 706, connection ports 708, a processing unit, such as Central Processing Unit (CPU) 710 and a memory storage device, such as main memory 712, hard drive 714 and CD/DVD ROM drive 716.

Memory bus 718 couples main memory 712 to CPU 710. A system bus 706 couples hard drive 714, CD/DVD ROM drive 716 and connection ports 708 to CPU 710.

Multiple input devices may be provided, such as for example a mouse 720 and keyboard 722. Multiple output devices may also be provided, such as for example a video monitor 724 and a printer (not shown).

Computer system 700 may be a commercially available system, such as a desktop workstation unit provided by IBM, Dell Computers, Gateway, Apple, or other computer system provider. Computer system 700 may also be a networked computer system, wherein memory storage components such as hard drive 714, additional CPUs 710 and output devices such as printers are provided by physically separate computer systems commonly connected together in the network. Those skilled in the art will understand and appreciate that physical composition of components and component interconnections comprising computer system 700, and select a computer system 700 suitable for the establishing virtual machines 406.

When computer system 700 is activated, preferably an operating system 726 will load into main memory 712 as part of the boot strap startup sequence and ready the computer system 700 for operation. At the simplest level, and in the most general sense, the tasks of an operating system fall into specific categories—process management, device management (including application and user interface management) and memory management. For at least one embodiment incorporating Xen as noted above, the sequence of events may generally be described as bootloader, Xen hypervisor, virtual machine insanitation, operating system.

In such a computer system 700, the CPU 710 is operable to perform one or more of the methods of representative symbol generation described above. Those skilled in the art will understand that a computer-readable medium 728 on which is a computer program 730 for generating representation symbols may be provided to the computer system 700. The form of the computer-readable medium 728 and language of the program 730 are understood to be appropriate for and functionally cooperate with the computer system 700. Utilizing the memory stores, such as, for example, one or more hard drives 714 and main memory 712, the operable CPU 710 will read the instructions provided by the computer program 730 and operate to perform as storage system 400 and/or method 500 as described above. Moreover, in at least one embodiment, the computer system 700 is a SpectraLogic nTier 700.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A storage system comprising:
a policy based file system; and
a virtualization environment permitting native file system primitives among a plurality of virtual machines, each virtual machine having a virtual file system, each virtual file system structured and arranged with native file system operations to access, based on policy, a portion of the policy based file system.

2. The storage system of claim 1, wherein a first virtual machine is structured and arranged with a policy setting for managing the policy based file system in its entirety, a plurality of second virtual machines each having policy based access to at least a portion of the policy based file system via the first virtual machine.

3. The storage system of claim 1, wherein the policy based file system is provided by one or more non-virtual machines.

4. The storage system of claim 1, wherein there is a policy enforcement agent that controls policy based access for at least one of the virtual machines to the policy based file system.

5. The storage system of claim 4, wherein the policy enforcement agent is a virtual machine.

6. The storage system of claim 1, wherein at least two of the virtual machines possess virtual file systems that are structured and arranged to natively access a single instance of a file in the policy based file system.

7. The storage system of claim 1, wherein each of the virtual file systems appears as a local file system provided by a non-volatile storage device to its associated virtual machine.

8. The storage system of claim 1, wherein each of the virtual file systems appears as a complete file system to its associated virtual machine.

9. The storage system of claim 1, wherein the portion of the policy based file system available to each virtual machine is not remapped to a file that is structured and arranged as a virtual non-volatile storage access device.

10. The storage system of claim 1, wherein the policy based file system is provided by a first computer system adapted to operate as a policy based file provider and at least one of the virtual machines is provided by a second computer system adapted to operate as at least one virtual machine having a virtual file system.

11. The storage system of claim 1, wherein each native file system primitive is one or more file system operations.

12. The storage system of claim 1, wherein the policy system is a central policy based system.

13. A method for a storage system comprising:
providing a policy based file system;
providing a virtualization environment permitting native file system primitives for virtual machines;
providing a plurality of virtual machines each having a virtual file system that is structured and arranged with the native file primitives to access at least a portion of the policy based file system; and
permitting the virtual machines to operatively interact with the policy based file system based on a predetermined access policy associated with each of the virtual machines.

14. The method of claim 13, further comprising natively allocating a single instance of a file in the policy based file system to at least two of the virtual machines in accordance with the access policy of each of the virtual machines.

15. The method of claim 13, further comprising:
providing a first virtual machine with a policy setting for managing, entirely, the policy based file system; and
providing a plurality of second virtual machines, each having policy based access to at least a portion of the policy based file system through the first virtual machine.

16. The method of claim 13, further including performing essentially real-time file maintenance on the policy based file system concurrently with access of the policy based file system by one or more of the virtual machines.

17. The method of claim 13, wherein the portion of the policy based file system available to one of the virtual machines is not remapped to a file that is structured and arranged as a virtual non-volatile storage access device.

18. The method of claim 13, wherein the policy based file system is provided by at least one computer having at least one processing unit, a memory storage device coupled to the processing unit, an input device coupled to the processing unit and an output device coupled to the processing unit, the processing unit being operative to adapt the computer as a dedicated policy based file system.

19. The method of claim 13, wherein there is a policy enforcement agent that controls policy based access for at least one of the virtual machines to the policy based file system.

20. The method of claim 19, wherein the policy enforcement agent is one of the virtual machines.

21. The method of claim 13, wherein the policy system is a central policy based system.

22. The method of claim 13, wherein each of the native file system primitives is one or more file system operations.

23. A storage system comprising:
means for providing a policy based file system;
means for providing a virtualization environment permitting native file system primitives for virtual machines;
means for providing a plurality of virtual machines each having a virtual file system that is structured and arranged with native file primitives to access at least a portion of the policy based file system; and
means for permitting the virtual machines to operatively interact with the policy based file system based on each virtual machines predetermined access policy.

24. The storage system of claim 23, wherein the means for providing the policy based file system permits allocation of a single instance of a file in the policy based file system to at least two virtual machines.

25. The storage system of claim 23, wherein the means for permitting the virtual machines to interact operatively with the policy based file system does not require the portion of the policy based file system that is available to each of the virtual machines to be remapped to a file that is structured and arranged as a virtual non-volatile storage access device.

26. The storage system of claim 23, further comprising policy enforcement means for controlling policy based access for at least one of the virtual machines to the file system.

27. A storage system for virtual machines comprising:
at least one processing unit;
at least one memory storage device coupled to the processing unit;
an input device coupled to the processing unit;
an output device coupled to the processing unit;
the processing unit being operative to adapt the storage system as a dedicated storage system for virtual machines by:
providing a policy based file system having one or more files therein;
providing a virtualization environment permitting native file system primitives for virtual machines;
providing a plurality of virtual machines each having a virtual file system that is structured and arranged with the native file primitives to access at least a portion of the policy based file system; and
permitting the virtual machines to operatively interact with the policy based file system based on a predetermined access policy associated with each of the virtual machines.

28. The storage system of claim 27, wherein the portion of the policy based file system available to each of the virtual machines is not remapped to a file that is structured and arranged as a virtual non-volatile storage access device.

29. The storage system of claim 27, wherein there is a policy enforcement agent that controls policy based access for at least one of the virtual machines to the policy based file system.

30. The storage system of claim 30, wherein the policy enforcement agent is one of the virtual machines.

31. The storage system of claim 27, wherein at least two of the virtual machines possess virtual file systems that are structured and arranged to natively access a single instance of a file in the policy based file system.
